(19) United States
(12) Patent Application Publication
(10) Pub. No.: US 2008/0147696 A1
(43) Pub. Date: Jun. 19, 2008

(54) METHOD FOR REDUCING MEMORY SIZE ALLOCATED BY A STRING CLASS USING UNICODE

(75) Inventor: Kazuaki Ishizaki, Tokyo (JP)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/612,560

(22) Filed: Dec. 19, 2006

(51) Int. Cl. G06F 17/30

(52) U.S. Cl. 707/101; 707/E17.002

(57) ABSTRACT

A method for reducing memory size allocated by a string using Unicode, including converting a plurality of Unicode strings into a string class, and storing the string class representing the converted plurality of Unicode strings into memory. The Unicode strings are storable in a compressed format.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to memory, and more particularly, to memory size allocated by a string class.

2. Description of Background

Java language provides the java.lang.String class and java.lang.StringBuffer class for representing strings. C# language provides String class and System.text.StringBuilder class, and VB.NET language provides String type and System.String type in Common Language Infrastructure (referred to as String classes throughout this disclosure) for representing strings. The common characteristic of these String classes is that they use Unicode to represent a string in order to support multiple languages. However, with Unicode, one character is represented using 16 bits, which requires more memory than a character string at 8 bit width as with a conventional C language char [ ]. As a result, each time a String class is created, a large amount of memory is necessary. Also, each time the character String class is referenced, other data is flushed from the cache memory, resulting in the cach miss rate being high, which can deteriorate program performance.

The String class for WebSphere consumes a considerable amount of memory, which can cause cache misses and thus deteriorate performance. Data indicates that 20-40% of Java Heap in the WebSphere is consumed by data related to String classes.

Thus, there is a need for a method to reduce the amount of memory used for a String class by not introducing a new class.

### SUMMARY OF THE INVENTION

The shortcomings of the prior art are overcome and additional advantages are provided through the provision of a method for reducing memory size allocated by a string using Unicode. The method includes converting a plurality of Unicode strings into a string class. The method further includes storing the string class representing the converted plurality of Unicode strings into memory. The Unicode strings are storable in a compressed format.

Additional features and advantages are realized through the techniques of the present invention. Other embodiments and aspects of the invention area described in detail herein and are considered a part of the claimed invention. For a better understanding of the invention with advantages and features, refer to the description and to the drawing.

### TECHNICAL EFFECTS

As a result of the summarized invention, technically we have achieved a solution for a method for reducing memory size allocated by a string using Unicode.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a method for reducing memory size allocated by a string Unicode;

FIG. 2 illustrates one example of a state transition diagram in accordance with the method disclosed in FIG. 1;

FIG. 3 illustrates one example of a program before and after conversion using the method disclosed in FIG. 1;

FIG. 4 illustrates one example of another state transition diagram in accordance with the method disclosed in FIG. 1;

FIG. 5 illustrates one example of the disclosed method being applied to source code;

FIG. 6 illustrates another example of the disclosed method being applied to source code; and

FIG. 7 illustrates another example of the disclosed method being applied to source code.

The detailed description explains an exemplary embodiment of the invention, together with advantages and features, by way of example with reference to the drawing.

### DETAILED DESCRIPTION OF THE INVENTION

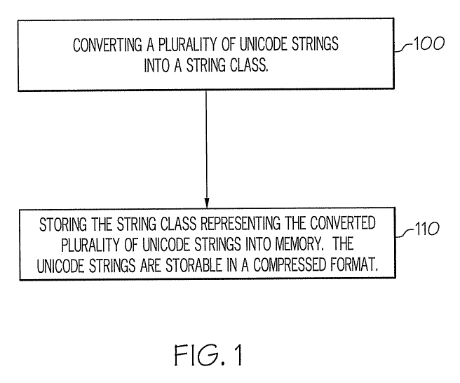

Referring to FIG. 1, a method for reducing memory size allocated by a string using Unicode is shown. The disclosed method includes a combination of two technologies. The method disclosed resolves the issue of reducing the amount of memory used for storing Unicode strings as a String class. A Unicode string is represented using 16 bit width for each character (32 bit may be used in certain cases).

At step 100, a plurality of Unicode strings are converted into a string class. Most String classes used by programs store data represented using 8 bit width in the range from 0×00 to 0×ff where the upper 8 bit is 0 when UTF16 is used. As seen in wastes memory. To avoid this waste, at step 110, the disclosed method stores a Unicode stored in the String class using 8 bit width provided it is possible to represent all characters only one character cannot be represented using 8 bit width, a conventional method is used to store the Unicode string to an array using a 16 bit width.

When a string stored using the 8 bit width is referenced, the string is read from the memory as 8 bit and is converted to 16 bit data without a sign extension (for example, upper 8 bit of the data, which is read as 8 bit width, can be masked off by performing an AND operation with 0×00ff, and it is then converted to 16 bit data). This process can be executed by one computer instruction. Power PC uses a 1 hz instruction and 1A-32 uses a MOVZX instruction. The number of executing instructions is the same as that for reading a string using 16 bit width.

When a string is stored as a String class and only the character code is checked, it is possible to reduce the amount of memory used to represent Unicode strings by half without overhead when the string in the String class is referenced. When a string stored in compressed format is referenced, the compressed string is uncompressed and the string result is returned as its original character value.

When the Unicode strings are stored as a String class, the storing process is effective for space and process speed in order to determine when compression has been used and when compression has not been used.

The Java language java.lang.String class and C# language String class are both immutable classes where stored string contents are never changed after a class instance has been created the first time. Therefore, if the string contents are checked once when the class instance is created, it is not necessary to change the width of the string storage area, making it possible to apply the disclosed method effectively to these classes.

The stored in Java language java.lang.StringBuffer class and C# language System.text.StringBuilder class may change after a class instance has been created. Therefore, there is a possibility that the width of the string storage area maybe extended. In such cases, string contents need to be copied from the 8 bit width array to the new 16 bit width array. After it is copies, the Java Garbage Collector (“GC”) can reclaim the original 8 bit array. As such, the amount of memory used is less than the amount used for conventional methods.

Generally speaking, there are two common methods for reducing the amount of memory storage space when a Unicode string is stored. One is a text compressing method and the other is the Unicode compression method. However, these compression methods require more complex decompression when a string in the String class is referenced, which may increase execution time. Also, when a substring of the string is referenced, it is necessary to execute decompression starting from the beginning of the string. This increases the amount of overhead for execution time and space. Therefore, except for cases when a program analysis detected a whole string is referenced, the disclosed method is effective.

When the disclosed method is used to store a Unicode string as a String class, it is effective for space and process speed to determine the cases when compression is used and when it is not used. When the disclosed method is used, the String class that stored the Unicode string in 8 bit width array and with the String class that stores the Unicode string in 16 bit width array exist together in a program. Therefore, the determination with the space and processing speed efficiency is important. The following illustrates two approaches that are being proposed.

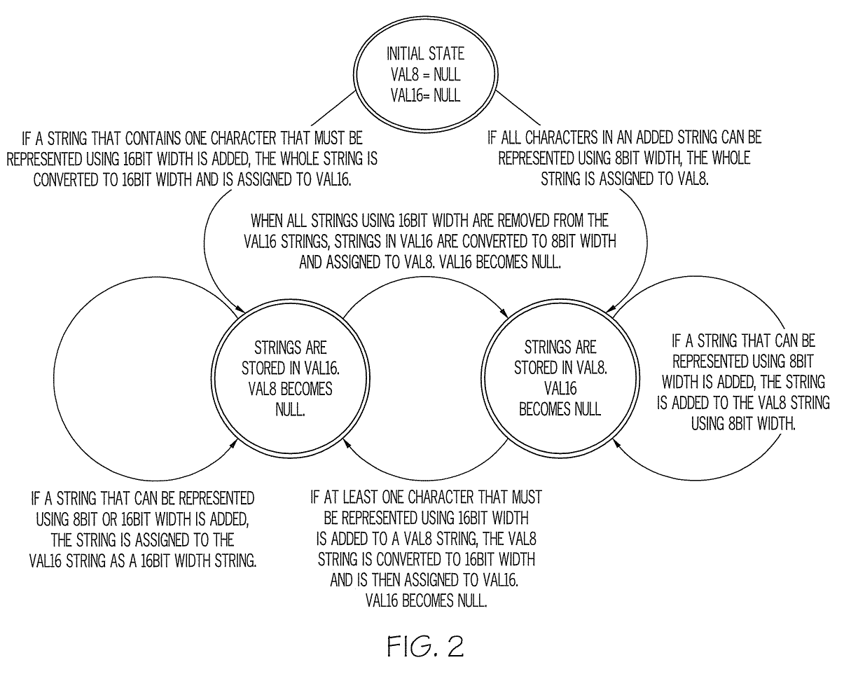

Referring to FIG. 2, a state transition diagram of when the string in the String class changes is shown. A first approach installs a new field into the String class. This approach installs a new field for keeping an 8 bit array such as when the field name is val8, in addition to the field that kept the original 16 bit width array for representing a Unicode string as a String class such as when the field name is val16.

The Java language java.lang.String class and C# language String class are immutable classes that do not change the contents of stored strings after a class instance is created one time. As such, when the conditions for the String class are determined during class instance creation as shown in the double circles, state transition can be simplified because the conditions do no change.

When a string that is represented by the String class is referenced, it is determined whether the value is contained in either val8 or val16 according to the above state transition diagram. The pointer that points to the string is taken from the non null portion of the val16 field or the val8 field, and then the value is read and the characters are returned. If the value is read using val8 8 bit width, it is necessary to expand the value to 16 bit without using a sign extension without a sign extension using one instruction. Therefore, converting from 8 bit to 16 bit can be executed without any execution time overhead.

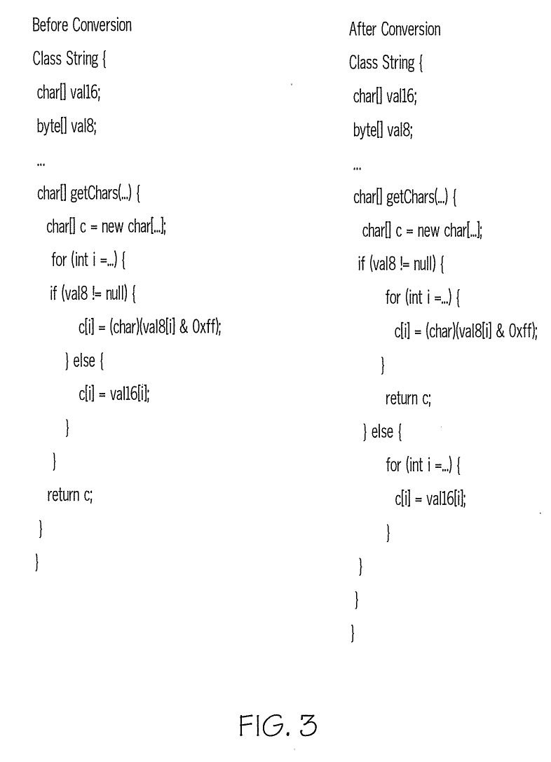

Referring to FIG. 3, an example program before and after conversion is shown. An API in String class may exist that can read multiple characters. In such cases, it is necessary to verify whether the val16 field or the val8 field will become non null one time before the loop that reads multiple characters. However, each time one character is read in the loop that reads multiple characters and has been verified that either the val16 field or the val8 field becomes non null, a code for reading each character is written, which causes overhead. Therefore, based on the loop versioning method disclosed, the compiler automatically converts the above code to the code that executes verification once to determine whether the val16 field or the val8 field become non null before executing the loop. Then, when a character is read, conversion is executed without the verification in the loop. This makes it possible to reduce overhead for the execution time.

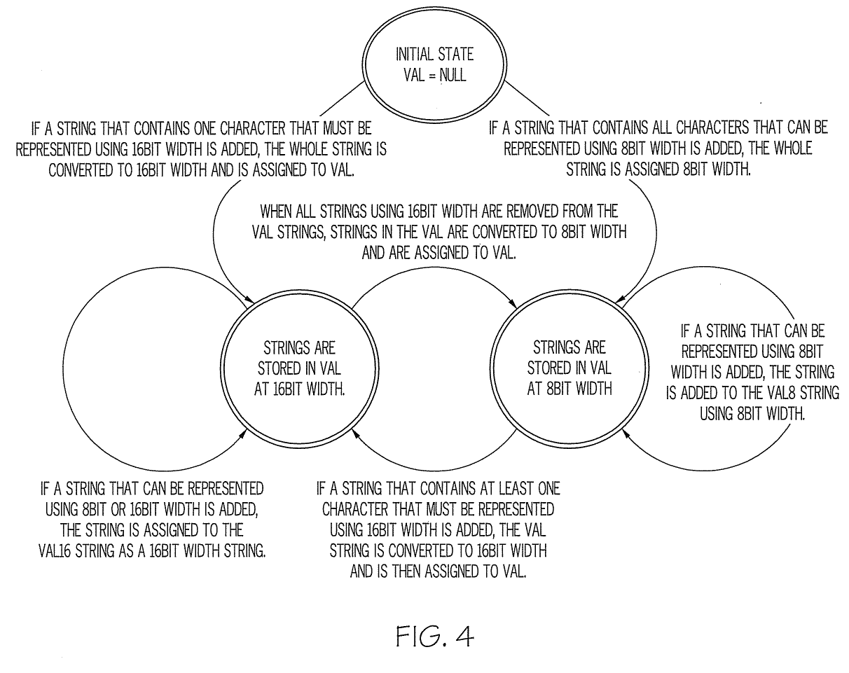

Referring to FIG. 4, a state transition diagram of when the strings in the String class are changed is shown. A second approach uses different types of an array to store Unicode strings. The first approach described above requires installation of a new field to the String class, which slightly increases the amount of memory. The disclosed method may significantly reduce the amount of memory used for storing strings. However, the String class is a fundamental class and is often used in programs. Therefore, it is necessary to keep the same number of fields for the String class. In order to met this requirement, 16 bit width strings that are contained in the String class representing the Unicode string and 8 bit width strings that can be represented using 8 bit width are stored in the same field such as in a field named val. The field type must be a language and C# language (for example, Java language needs an Object type).

The Java language java.lang.String class and C# language String class are immutable classes that do not change the contents of stored strings after a class instance is created one time. As such, when the state for the String class are determined during class instance creation as shown in the double circles, state transition can be simplified because the states do not change. When the string represented by the String class is referenced, it is determined whether strings represented using 8 bit width are stored in the val field or whether strings represented using 16 bit width are stored in the val field by performing type check against an array stored in the val field. Then the value is read and the character is returned. Based on previous studies, it is possible to perform a type check quickly. If the value is read using val8 bit width, it is necessary to expand the value to 16 bit without a sign extension. Power PC and IA-32 can execute load and bit extension without a sign extension using one instruction. Therefore, converting from 8 bit to 16 bit can be executed without any execution time overhead. In addition, by using loop versioning in the same manner as in the first approach, it is possible to reduce execution time overhead when multiple characters are read.

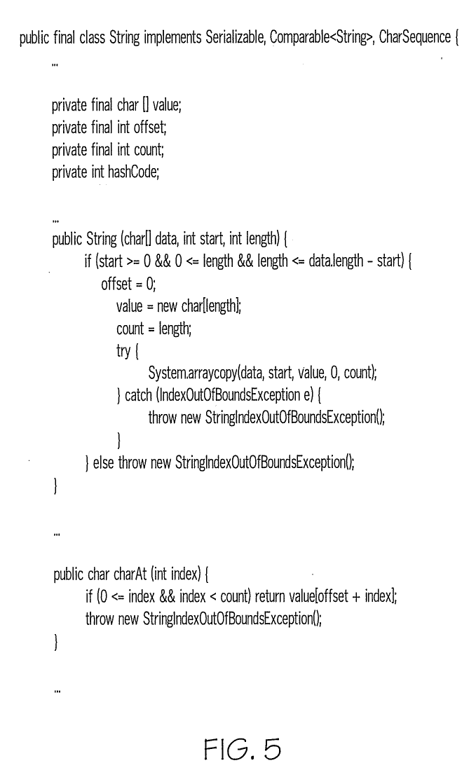

Referring to FIG. 5, an illustration of an embodiment of the invention that may be applied to the Java language java.lang.String class is shown. First of all, the following shows a part of the java.lang.String class source code of the IBM Developers Kit for Java 5 prior to the disclosed method being applied. The field that is used in the java.lang.String, as the representative methods, the constructor of the java.lang.String class that sets up the strings, the charAt( ) method that gets one character from the java.lang.String, and the getChars ( ) that copies part of the java.lang.String to provide a char [ ] buffer area shown.

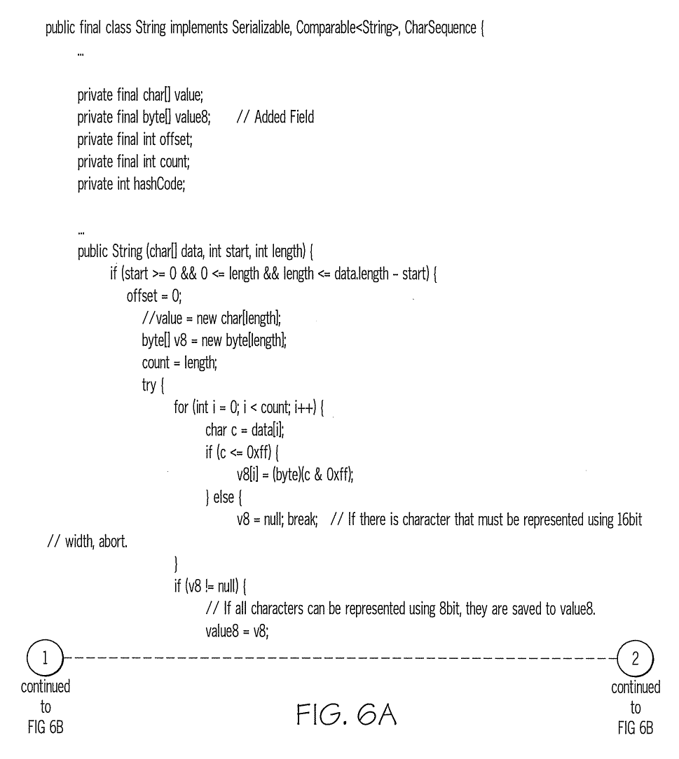

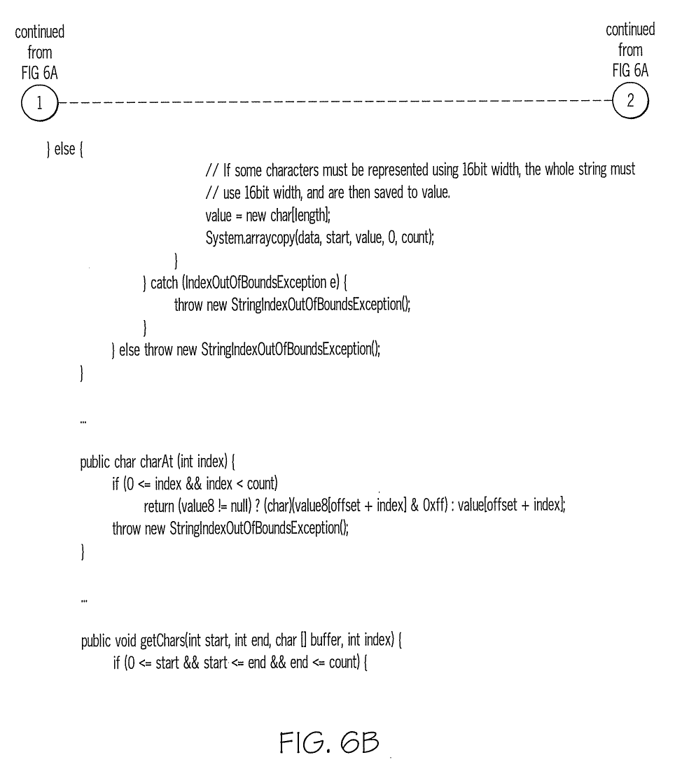

Referring to FIG. 6, an illustration of the disclosed method being applied to the source code previously mentioned in install a new field to the String class is shown.

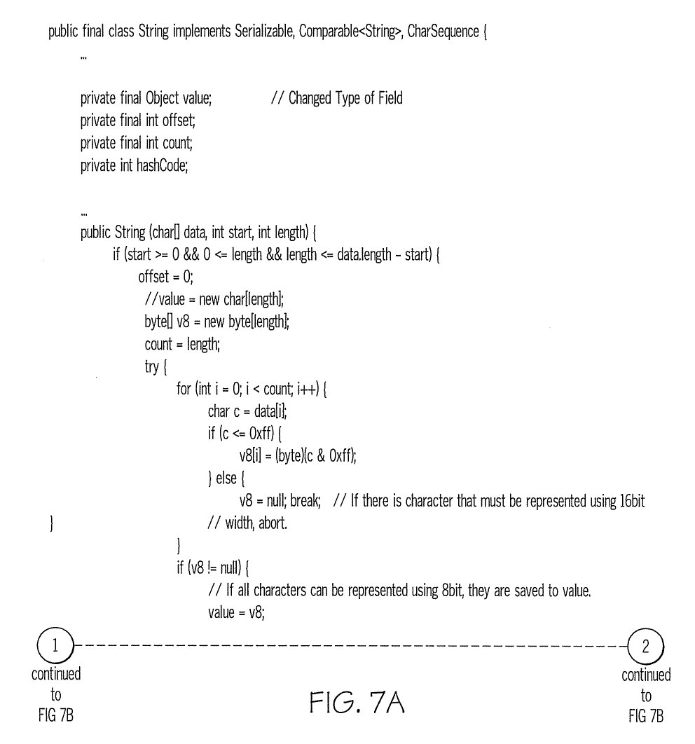

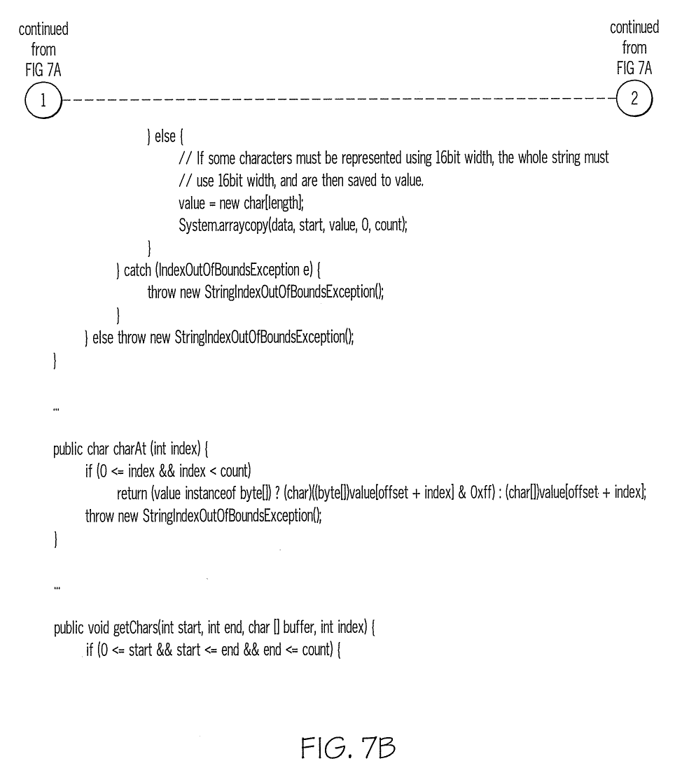

Referring to FIG. 7, an illustration of the disclosed method being applied to the source code previously mentioned to use different types of arrays to store Unicode strings is shown.

When a String class is used with conventional technology, a large amount of memory is used. Also, when a String class is referenced, other data is flushed from the cache and performance deteriorates. These problems are resolved by application of the disclosed method. Provided the Setter/Getter methods are utilized as the String class, the implementation of the class library, the runtime system, and compiler need to be changed, but the user code does not need to be changed. Therefore, it is possible to apply the disclosed method to actual runtime systems easily.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for reducing memory size allocated by a string using Unicode, comprising:
converting a plurality of Unicode strings into a string class;
storing the string class representing the converted plurality of Unicode strings into memory; and
wherein the Unicode strings are storable in a compressed format.

2. A method as set forth in claim 1, wherein when a string stored in compressed format is referenced, the compressed string is uncompressed and the string result is returned as its original character value.

3. A method as set forth in claim 2, wherein when the Unicode strings are stored as a string class, the storing process is effective for space and process speed in order to determine when compression has been used and when compression has not been used.

4. A method as set forth in claim 3, wherein when the string contents are checked once upon creation of the class instance, it is not necessary to change the width of the string storage area.
